(19) United States
(12) Patent Application Publication
(10) Pub. No.: US 2011/0292414 A1
(43) Pub. Date: Dec. 1, 2011

(54) TWO-SIDED DOCUMENT COPYING

(76) Inventor: Nagajothi Nagappan, Singapore (SG)

(21) Appl. No.: 12/791,236

(22) Filed: Jun. 1, 2010

(51) Int. Cl. G06F 15/00; H04N 1/04

(52) U.S. Cl. 358/1.9; 358/474

(57) ABSTRACT

Methods and apparatus pertaining to copying two-sided documents are provided. An all-in-one, multi-function device provides an identification card copy selection to a user by way of a user interface. The device prompts the user during scanning of the front and back sides of the ID card. The device prints images of both the front and back sides of the ID card on the same side of a sheet of media. Identification card scanning and printing are performed as a walk-up procedure without need for user computer or network entity intervention.

### BACKGROUND

All-in-one devices are a class of multi-function, media handling apparatus. Various documents, entities and electronic files can be copied, scanned and/or printed. Typically, an all-in-one device is cooperatively coupled to a computer or network.

Sometimes, a user desires specialty copying or printing operations that are not performed by the all-in-one's built-in functions or by software running on an associated computer. The present teachings are directed to the foregoing concerns.

### BRIEF DESCRIPTION OF THE DRAWINGS

The present embodiments will now be described, by way of example, with reference to the accompanying drawings, in which:

FIG. 1 is a plan view of a two-sided document in according to the prior art;

FIG. 2 is an isometric view of an operational scenario according to one embodiment of the present teachings;

FIG. 3 is a block diagram of a system according to one embodiment;

FIG. 4 is a flow diagram depicting a method according to one embodiment;

FIG. 5 is a plan view depicting a printed document in accordance with one embodiment;

FIG. 6 is a plan view depicting a printed document in accordance with another embodiment.

### DETAILED DESCRIPTION

### Introduction

Methods and apparatus pertaining to copying two-sided documents are provided. An all-in-one, multi-function device provides an ID card copy function selection to a user by way of a user interface. The device prompts the user during scanning of the front and back sides of the ID card. The device prints images of both the front and back sides of the ID card on the same side of a sheet of media. Identification card scanning and printing are performed as a simple, walk-up procedure without need for user computer or network entity intervention.

In one embodiment, an apparatus includes a user interface configured to display at least one user prompt corresponding to copying a document having a first side and a second side. The apparatus also includes a scanner configured to provide signals corresponding to image content of the first and second sides of the document. The apparatus further includes a printer configured to print respective images of the first and second sides of the document on a single side of a sheet media by way of the signals.

In another embodiment, a method includes scanning a first side of a document using a device. The method also includes scanning a second side of the document using the device. The method further includes printing respective images of the first and second sides of the document on a single side of a sheet media using the device.

In yet another embodiment, a tangible computer-accessible storage media stores a program code. The program code is configured to cause a machine to prompt a user with respect to copying a two-sided document. The program code is also configured to cause the machine to scan a first side of the document and scan a second side of the document. The program code is further configured to cause the machine to print respective images of the first and second sides of the document on a single side of a sheet media.

### First Illustrative Document

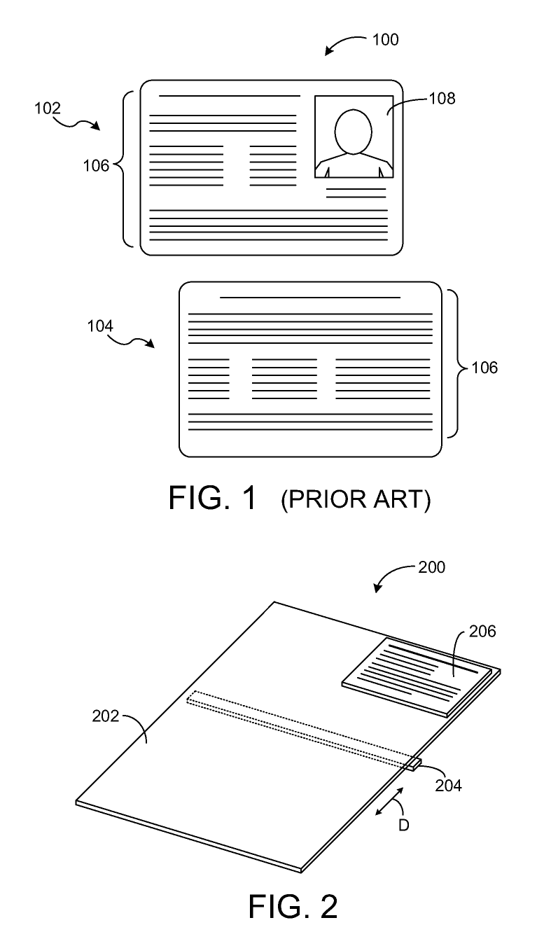

Reference is now directed to FIG. 1, which depicts a plan view of a two-sided document 100. The document 100 is an identification card (ID card) as is generally known in the prior art. The ID card 100 is illustrative and non-limiting with respect to two-sided documents usable in accordance with the present teachings. Thus, other two-sided documents can also be used.

The ID card 100 includes a front or face side 102 and a back or reverse side 104. Each of the two sides 102 and 104 includes respective writings, texts, symbols, alphanumeric content or other indicia 106. The front side 102 further includes a photographic image 108. In general, the ID card (i.e., document) 100 can include essentially any visible image content.

It is to be understood that the two sides 102 and 104, collectively, include image content 106-108 that is significant in various contexts. It is further understood that the document 100 owner or other entities have a need or desire to accurately copy the collective image content 106-108 for record keeping, identity verification or other purposes at one time or another.

### First Illustrative Operating Scenerio

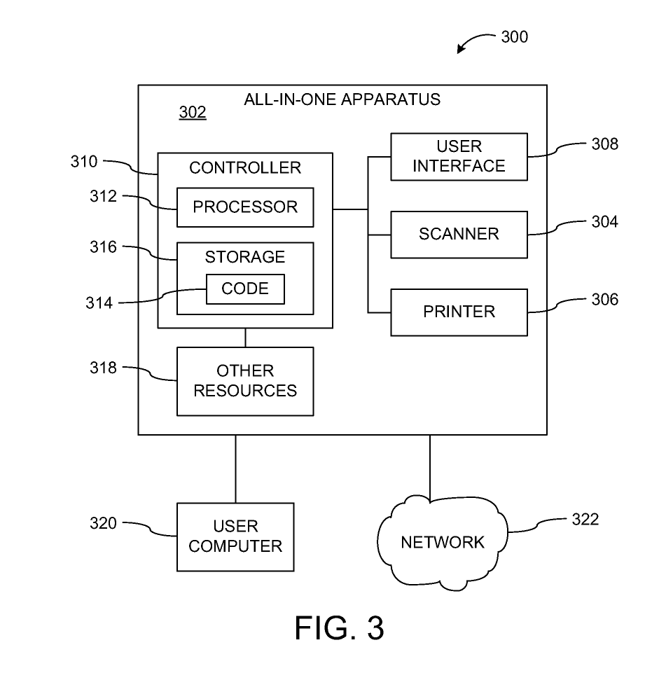

Attention is now directed to FIG. 2, which is an illustrative operating scenario 200 according to one embodiment of the present teachings. The scenario 200 is illustrative and non-limiting in nature. Thus, other operations can also be defined or performed in accordance with the present teachings.

The scenario 200 includes a scanner bed or platen 202. The scanner platen 202 can be formed of glass or another suitable transparent material. The scenario 200 further includes an optical scanning apparatus 204 disposed in cooperative proximity to the scanner platen 202. The scanning apparatus 204 is configured to translate with respect to the scanner platen 202 as shown by the bidirectional arrow “D”. The scanning apparatus 204 is further configured to optically scan image content of documents or objects placed on the scanner platen 202 and to provide electronic signals or digital data corresponding thereto.

The scenario 200 further includes an identification (ID) card 206 supported on the scanner platen 202. In the interest of simplicity, the ID card 206 is understood to be equivalent to the ID card 100. The ID card 206 is thus a two-sided document including text, indicia, or other images on the respective sides.

As depicted, the ID card 206 is understood to be oriented with a face side (e.g., 102) in contact with the scanner platen 202. The face side of the ID card 206 can therefore be optically scanned by the scanning apparatus 204 so as to provide electronic signals corresponding to the image content (e.g., 106-108, etc.). In turn, the back side (e.g., 104) of the ID card 206 can be placed in on the scanner platen 204 so that the image content thereof can be scanned. Both sides of the ID card 206 can be scanned using a sequential, one-side-and-then-the-other procedure so as to electronically capture all of the image content of the ID card 206.

### First Illustrative System

FIG. 3 depicts a block diagram of a system 300 according to the present teachings. The system 300 is illustrative and non-limiting with respect to the present teachings. Other systems, devices and apparatus can also be defined and used in accordance with the present teachings.

The system 300 includes an all-in-one or multi-function media handling apparatus 302. The apparatus 302 is configured to perform various scanning and printing operations by way of a scanner 304 and a printer 306. The scanner 304 can be variously defined. In one embodiment, the scanner 304 is configured to scan images of documents or objects, and to provide corresponding electronic signals or digital data. In turn, the printer 306 can be defined by an ink-jetting printer, a laser printer, or other suitable construct configured to form images in one or more colors on sheet media such as paper, etc.

The apparatus 302 also includes a user interface 308. The user interface 308 is configured to provide indications and information to a user, and to receive input and operational selections from the user. As such, the user interface 308 can include one or more pushbuttons or switches, a keypad, an electronic display screen, a touch-sensitive display with soft or virtual key images, indicating lights, etc. One having ordinary skill in the relevant arts can appreciate that the user interface 308, the scanner 304 and the printer 306 can be variously defined.

The all-in-one apparatus 302 also includes a controller 310. The controller 310 is configured to control one or more normal operations of the apparatus, including respective operations of the user interface 308, the scanner 304 and the printer 306. The controller 310 can include any suitable electronic circuitry or resources. As depicted, the controller 310 includes a processor 312. The processor 312 is configured to operate in accordance with a computer-accessible program code 314 stored within a storage media 316.

In turn, the storage media 316 is defined by any suitable tangible, computer-accessible storage media. In one embodiment, the storage media 316 is defined by non-volatile storage memory. Other suitable storage media can also be used. The apparatus 302 further includes other resources 318. Other resources 318 can include any suitable devices, sub-systems or entities as desired or required for normal operations of the all-in-one apparatus 302. Non-limiting examples of such other resources 318 include a power supply, input/output circuitry, wireless communications circuitry, a network communications card, etc.

The system 300 also includes a user computer 320. The user computer 320 can be defined by any desktop, laptop or other processor-based platform configured to perform various functions according to computer program code. The user computer 320 is understood to be configured to communicate with the all-in-one apparatus 302 by way of control and data signals. Thus, for non-limiting example, a user of the computer 320 can transmit an electronic document to the apparatus 302 for printing onto sheet media. Other various normal operations can also be performed. One having ordinary skill in the computer and related arts can appreciate that the use computer 320 can be variously defined and can cooperate with the all-in-one apparatus 302 toward performing various functions.

The system 300 also includes a network 322. The network 322 can be defined by or be coupled to the Internet, a local area network, a wide area network, etc. The all-in-one apparatus 302 can be configured to receive printable data files from the network 322, transmit data files of scanned documents to the network 322, etc. Numerous other normal operations can also be performed by way of cooperation between the all-in-one apparatus 302 and the network 322.

Non-limiting, normal operations of the all-in-one apparatus 302 include copying (i.e., scanning and printing) of identification cards and other two-side documents. For purpose herein, the user interface 308, the scanner 304 and the printer 306 are operated, under the influence of the controller 310, to provide printed sheet media. Such sheet media include images of a front side and a back side of two-sided document on a single side of the sheet media. One method of operation toward this goal is described hereinafter. The all-in-one apparatus 302 can also be used to perform various other normal operations, as well.

### First Illustrative Method

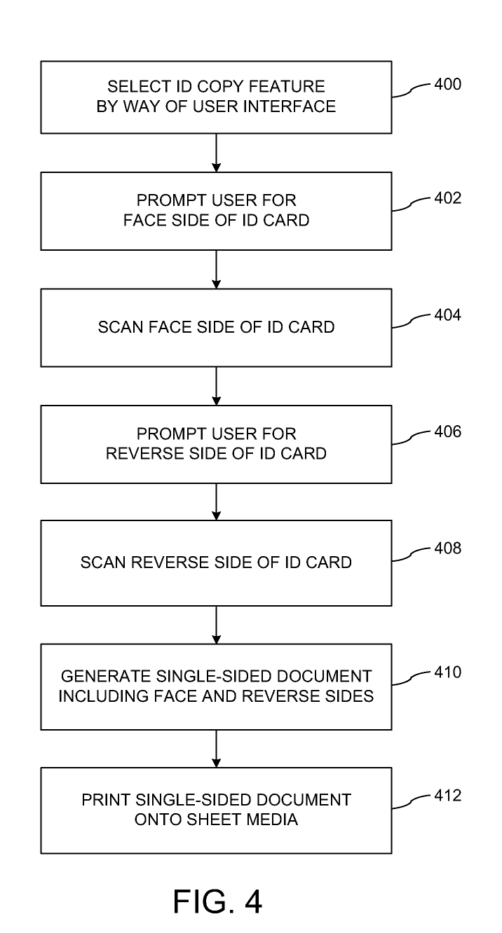

Attention is directed to FIG. 4, which depicts a flow diagram of a method according to one embodiment of the present teachings. The method of FIG. 4 includes particular operations and order of execution. However, other methods including other operations, omitting one or more of the depicted operations, and/or proceeding in other orders of execution can also be used according to the present teachings. Thus, the method of FIG. 4 is illustrative and non-limiting in nature. Reference is also made to FIGS. 1-3 in the interest of understanding the method of FIG. 4.

At 400, an identification (ID) copy feature is selected by way of a user interface of an all-in-one apparatus. For purposes of non-limiting example, it is assumed that a user presses an icon or “soft-button” corresponding to an ID Copy feature on a touch-sensitive display of the user interface 308 of the apparatus 302. Other types of user input such as hardware button presses, etc., can also be used.

At 402, a prompt is provided to the user for the face side of the card. For purposes of the present example, it is assumed that the user interface 308 provides graphical, text or audible information—or a combination thereof—to the user instructing the user to place the ID card face side-down on a platen 202 of the scanner 304. Such prompting can also include information related to orientation or location of the card on the platen 202, etc. The user then confirms that the ID card placement step has been performed by corresponding input to the user interface 308.

At 404, the face side of the ID card is scanned. For purposes of the present example, the scanner 304 optically scans the ID card on the platen 202 and generates a corresponding electronic image file or data set. This electronic file or data is stored, at least temporarily, by the controller 310.

At 406, a prompt is provided to the user for the reverse side of the card. For purposes of the present example, it is assumed that the user interface 308 provides information to the user requesting that the ID card be placed back side-down on a platen 202. That is, the user is instructed to turn the ID card over with respect to its present orientation. The user then confirms that this step has been performed by corresponding input to the user interface 308.

At 408, the reverse side of the ID card is scanned. For purposes of the present example, the scanner 304 optically scans the back side of the ID card on the platen 202. Additionally, a corresponding electronic image file or data set is generated, and is stored, at least temporarily, by the controller 310.

At 410, a single-sided document is generated including the face and reverse sides of the ID card. For purposes of the present example, the face and reverse side-images of the ID card are combined into a single electronic image or file. The images are located in a predetermined proximity and orientation with each other within the image file. However, it is important to note that the respective side images are placed so as to fit within the printable area of a single side of sheet media handled by the all-in-one apparatus 302.

At 412, the single-sided document is printed onto sheet media. For purposes of the present example, it is assumed that the controller 310 communicates the single-sided image file to the printer 306. The printer 306 then prints the document onto a single side of a sheet of media (i.e., letter-sized white paper, etc.). As a result, the user is provided with a single sheet media having both the face and reverse sides of the ID card imaged thereon. Such a printed media can then be used for other purposes.

In general, and without limitation, the present teachings contemplate a variety of methods and apparatus for printing images of a two-sided document onto a single side of a sheet of media. Non-limiting examples of such a two-sided document include a driver's license, state ID card, military ID card, machine operators permit, etc. A multi-function or all-in-one apparatus is configured to perform the operations described herein.

A user selects a two-side or an “ID COPY” function on an all-in-one device. The user is then prompted through the sequence of placing the document or ID card in cooperative orientation with a scanner of the all-in-one. After both front and back sides of the document are scanned, a printed sheet media is produced by the all-in-one, having both the front and back images on a single side of the media.

The foregoing method provides a single-sided document that is convenient for viewing, filing or other uses, and that is inclusive of all of the image content of the original document or ID card. The respective method steps 400-412 described above can be performed, at least in part, in accordance with a program code 314 within a computer-accessible storage media.

It is important to note that the devices and apparatus contemplated by the present teachings are configured to operate without support from or cooperation with any other entity or entities. Thus, an all-in-one apparatus in accordance with the present teachings is configured to perform two-sided ID card copying (scanning and printing) in an independent, stand-alone mode of operation. For non-limiting example, no cooperation with the user computer 320 or entities of the network 322 is needed to perform the method of steps 400-412.

### First Illustrative Printed Document

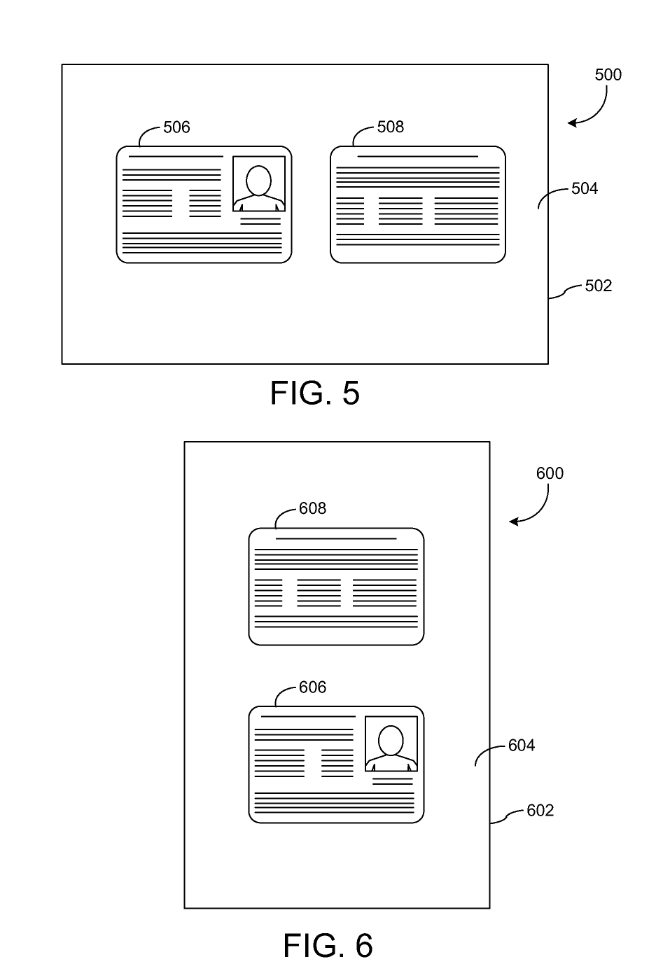

Attention is now directed to FIG. 5, which depicts a printed document 500 in accordance with one embodiment of the present teachings. The document 500 is illustrative and non-limiting with respect to the present teachings. Other printed documents, image placement formats or aspects can also be used.

The document 500 includes a sheet of media 502 defined by a first side 504. The document 500 also includes a first image 506 and a second image 508 printed on the first side 504 of the sheet media 502. The first and second images 506 and 508 correspond to image content of face and reverse sides of an identification card, respectively.

The placement of the images 506 and 508 are such that the sheet media 502 is normally viewed in a landscape orientation. In this way, the entire image content of the original ID card is provided on a single side of the sheet media 502. The document 500 is illustrative of various printed document that can be printed by apparatus of the present teachings (e.g., all-in-one 302, etc.). Document 500 depicts the first image 506 positioned on the left, and the second image 508 on the right of the sheet media 602. In another embodiment, the first and second images 506 and 508 can be printed in the opposite orientation.

### Second Illustrative Printed Document

Attention is now directed to FIG. 6, which depicts a printed document 600 in accordance with one embodiment of the present teachings. The document 600 is illustrative and non-limiting with respect to the present teachings. Other printed documents, image placement formats or aspects can also be used.

The document 600 includes a sheet of media 602 defined by a first side 604. The document 600 also includes a first image 606 and a second image 608 printed on the first side 604 of the sheet media 602. The first and second images 606 and 608 correspond to image content of face and reverse sides of an identification card, respectively.

The placement of the first and second images 606 and 608 are such that the sheet media 602 is normally viewed in a portrait orientation. In this way, the entire image content of the original ID card is provided on a single side of the sheet media 602. The document 600 is illustrative of printed document that can be produced by apparatus of the present teachings. Document 600 depicts the first image 606 underlying the second image 608 on the sheet media 602. In another embodiment, the first and second images 606 and 608 can be printed in the opposite orientation. Other image placement formats can also be used.

In general, the foregoing description is intended to be illustrative and not restrictive. Many embodiments and applications other than the examples provided would be apparent to those of ordinary skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. An apparatus, comprising:
a user interface configured to display at least one user prompt corresponding to copying a document having a first side and a second side;
a scanner configured to provide signals corresponding to image content of the first and second sides of the document; and
a printer configured to print respective images of the first and second sides of the document on a single side of a sheet media by way of the signals.

2. The apparatus according to claim 1, the first and second sides of the document defining an area sum lesser than an area of the single side of the sheet media.

3. The apparatus according to claim 1, further comprising a controller configured to control at least one of the user interface, the scanner, or the printer.

4. The apparatus according to claim 3, the controller including:
a computer-accessible storage media including a program code; and
a processor configured to control one or more operations of the apparatus in accordance with the program code.

5. The apparatus according to claim 1, the one or more user prompts including at least one of information for orienting the first or second sides of the document in cooperative relationship with the scanner, or information related to a sequence of scanning the first and second sides of the document with the scanner.

6. The apparatus according to claim 1, the images being printed on the sheet media by way of ink deposition.

7. The apparatus according to claim 1 further defined by a multi-function media handling device.

8. The apparatus according to claim 1 further configured to be coupled in cooperative association with a computer distinct from the apparatus.

9. The apparatus according to claim 8, the apparatus further configured to operate the user interface and the scanner and the printer so as to print the respective images of the first and second sides of the document on the single side of the sheet media without corresponding cooperation with the computer.

10. A method, comprising:
scanning a first side of a document using a device;
scanning a second side of the document using the device; and
printing respective images of the first and second sides of the document on a single side of a sheet media using the device.

11. The method according to claim 10 further comprising providing procedural information to a user by way of a user interface of the device.

12. The method according to claim 11, the procedural information including guidance as to at least a proper orientation of the document with respect to a scanner of the device, or a sequence of scanning the first side and the second side of the document.

13. The method according to claim 10, the method performed without cooperation with any machine distinct from the device.

14. A tangible computer-accessible storage media storing a program code, the program code configured to cause a machine to:
prompt a user with respect to copying a two-sided document;
scan a first side of the document;
scan a second side of the document; and
print respective images of the first and second sides of the document on a single side of a sheet media.

15. The tangible computer-accessible storage media according to claim 14, the program code further configured to cause the machine to perform the prompting and the respective scannings and the printing without corresponding cooperation with any other machine.
